(19) United States
(12) Patent Application Publication
(10) Pub. No.: US 2024/0052940 A1
(43) Pub. Date: Feb. 15, 2024

(54) VALVE DEVICE

(71) Applicant: MIKUNI CORPORATION, Tokyo (JP)

(72) Inventors: Satoshi SEKIGUCHI, Kanagawa (JP); Shoichi ISHIGUCHI, Kanagawa (JP)

(73) Assignee: MIKUNI CORPORATION, Tokyo (JP)

(21) Appl. No.: 18/331,187

(22) Filed: Jun. 8, 2023

(30) Foreign Application Priority Data
Aug. 11, 2022 (JP) 2022-128560

(51) Int. Cl. F16K 27/02; F16K 1/20; F16K 31/06

(52) U.S. Cl. CPC F16K 27/0232; F16K 1/2007; F16K 31/0655

(57) ABSTRACT

A valve device includes: a housing H, defining an upstream side passage 41a and a downstream side passage 22a through which a fluid passes, a valve accommodation chamber h1 interposed between the upstream side passage and the downstream side passage, and an opening part 41b located at a downstream end of the upstream side passage; and a cantilevered valve body 30, disposed in the valve accommodation chamber, and having a support part 32 that is elastically deformable and cantilevered and, on a free end side of the support part, a valve part 31 that is plate-shaped and opening and closing the opening part. In the valve device, the downstream side passage 22a is formed to expand in a direction along a plane 31a, 31b of the valve part in a state in which the valve part 31 is fully opened.

### CROSS-REFERENCE TO RELATED APPLICATION

This application claims the priority benefit of Japan application serial no. 2022-128560, filed on Aug. 11, 2022. The entirety of the above-mentioned patent application is hereby incorporated by reference herein and made a part of this specification.

### BACKGROUND

### Technical Field

The invention relates to a valve device opening or closing a passage of a fluid, and particularly relates to a valve device opening or closing a passage by using a cantilevered valve body (also called reed valve) having a plate-shaped valve part located on a free end side of a cantilever spring.

### Description of Related Art

As a conventional valve device, an electromagnetic valve (see, for example, Patent Document 1, Patent Document 2) including the following is known: an upstream side passage and a downstream side passage through which a fluid passes; a valve accommodation chamber interposed between the upstream side passage and the downstream side passage; an opening part (valve port) located at a downstream end of the upstream side passage; a cantilevered valve body disposed in the valve accommodation chamber and disposed so that a valve part on a free end side opens or closes the opening part; and a solenoid applying a driving force in a direction of closing the valve part of the cantilevered valve body.

In the electromagnetic valve, the upstream side passage and the downstream side passage are arranged on the same line, and the valve part of the cantilevered body, in a valve-opened state, occupies an intermediate region in the upstream side passage and the downstream side passage. Therefore, the fluid flowing in from the upstream side passage collides with the plate-shaped valve part from the front surface, and flows out to the downstream side passage after entering the back surface side of the valve part to avoid the valve part. That is, the fluid enters the back surface side after colliding with the front surface of the valve body, and, as an entire flow, flows to intersect with the surface of the valve body. Therefore, The flow from the back surface may be separated or stagnated, and the pressure loss of the fluid increases.

### PRIOR ART DOCUMENT(S)

### Patent Document(s)

[Patent Document 1] Japanese Laid-open No. 2020-12515
[Patent Document 2] Japanese Laid-open No. 5772343

### SUMMARY

A valve device according to an aspect of the invention includes: a housing, defining an upstream side passage and a downstream side passage through which a fluid passes, a valve accommodation chamber interposed between the upstream side passage and the downstream side passage, and an opening part located at a downstream end of the upstream side passage; and a cantilevered valve body, disposed in the valve accommodation chamber, and having a support part that is elastically deformable and cantilevered and, on a free end side of the support part, a valve part that is plate-shaped and opens and closes the opening part. The downstream side passage is formed to expand in a direction along a plane of the valve part in a state in which the valve part is fully opened.

### BRIEF DESCRIPTION OF THE DRAWINGS

FIG. 1 is a perspective view illustrating the appearance of a valve device according to an embodiment of the invention.

FIG. 2 is a plan view illustrating the valve device according to an embodiment.

FIG. 3 is an exploded perspective view, in which the valve device according to an embodiment is decomposed and obliquely viewed from a housing cover side.

FIG. 4 is an exploded perspective view, in which the valve device according to an embodiment is decomposed and obliquely viewed from a housing body side.

FIG. 5 is a plan view illustrating a state in which the housing cover is removed in the valve device according to an embodiment.

FIG. 6 is an exploded perspective view illustrating a cantilevered valve body included in the valve device according to an embodiment, and the cantilevered valve body is decomposed into a support part and a valve part.

FIG. 7 is a perspective view illustrating a solenoid embedded in the housing body of the valve device according to an embodiment.

FIG. 8 is an exploded perspective view in which the solenoid shown in FIG. 7 is decomposed.

FIG. 9 is a perspective cross-sectional view illustrating a state in which the valve part of the cantilevered valve body is closed in the valve device according to an embodiment.

FIG. 10 is a cross-sectional view illustrating a state in which the valve part of the cantilevered valve body is closed in the valve device according to an embodiment.

FIG. 11 is a perspective cross-sectional view illustrating a state in which the valve part of the cantilevered valve body is fully opened in the valve device according to an embodiment.

FIG. 12 is a cross-sectional view illustrating a state in which the valve part of the cantilevered valve body is fully opened in the valve device according to an embodiment.

FIG. 13 is a perspective cross-sectional view in which a housing cover is partially cut in the state in which the valve part of the cantilevered valve body is fully opened in the valve device according to an embodiment.

### DESCRIPTION OF THE EMBODIMENTS

The invention provides a valve device that reduces the pressure loss of a fluid by making the fluid smoothly flow around a cantilevered valve body.

A valve device according to the invention includes: a housing, defining an upstream side passage and a downstream side passage through which a fluid passes, a valve accommodation chamber interposed between the upstream side passage and the downstream side passage, and an opening part located at a downstream end of the upstream side passage; and a cantilevered valve body, disposed in the valve accommodation chamber, and having a support part that is elastically deformable and cantilevered and, on a free end side of the support part, a valve part that is plate-shaped and opens and closes the opening part. The downstream side passage is formed to expand in a direction along a plane of the valve part in a state in which the valve part is fully opened.

In the valve device, a configuration as follows may be adopted: the opening part is formed to be circular, the valve part is formed to be disc-shaped, and a region, of the support part, extending from the valve part is formed in an elongated plate shape.

In the valve device, a configuration as follows may be adopted: the housing includes: a cylindrical part, defining the upstream side passage to expand on a first axis; a pipe part, defining the downstream side passage to expand on a second axis inclined with respect to the first axis, with the second axis being set as a center; and a protrusion part, protruding in a radial direction from the cylindrical part to define a portion of the valve accommodation chamber, so as to accommodate a fixed side of the cantilevered valve body.

In the valve device, a configuration as follows may be adopted: the valve part includes a front surface facing the opening part and a back surface on a side opposite to the front surface, and the housing comprises a guide wall guiding the fluid flowing into a side of the back surface to the downstream side passage in the state in which the valve part is fully opened.

In the valve device, a configuration as follows may be adopted: the valve part includes a front surface facing the opening part and a back surface on a side opposite to the front surface, and the housing includes a guide wall guiding the fluid flowing into a side of the back surface to the downstream side passage in the state in which the valve part is fully opened, and the guide wall is formed to expand in a direction along the plane of the valve part in the state in which the valve part is fully opened.

In the valve device, a configuration as follows may be adopted: the pipe part and the protrusion part are disposed to be apart by 180° in a circumferential direction about the first axis.

In the valve device, a configuration as follows may be adopted: the housing includes a fully opened stopper part limiting a movement of the valve part in the state in which the valve part is fully opened.

In the valve device, a configuration as follows may be adopted: the valve device includes a solenoid applying a driving force in a direction of closing the valve part, and the cantilevered valve body includes the valve part formed by a magnetic material and the support part formed by a spring material.

In the valve device, a configuration as follows may be adopted: the housing includes a housing body defining the upstream side passage and a housing cover defining the downstream side passage and combined with the housing body, the housing body includes: a cylindrical part, defining the upstream side passage to expand on a first axis; and a protrusion accommodation part, partially defining a protrusion part, protruding in a radial direction from the cylindrical part to accommodate a fixed side of the cantilevered valve body, the housing cover includes: a pipe part, defining the downstream side passage to expand on a second axis inclined with respect to the first axis, with the second axis being set as a center; and the housing cover has a protrusion cover part partially defining the protrusion part and covers the protrusion accommodation part.

In the valve device, a configuration as follows may be adopted: the valve part includes a front surface facing the opening part and a back surface on a side opposite to the front surface, and the housing cover includes a guide wall guiding the fluid flowing into a side of the back surface to the downstream side passage in the state in which the valve part is fully opened.

In the valve device, a configuration as follows may be adopted: the valve part includes a front surface facing the opening part and a back surface on a side opposite to the front surface, the housing cover includes a guide wall guiding the fluid flowing into a side of the back surface to the downstream side passage in the state in which the valve part is fully opened, and the guide wall is formed to expand in a direction along the plane of the valve part in the state in which the valve part is fully opened.

In the valve device, a configuration as follows may be adopted: the housing body and the housing cover define the protrusion part, the housing cover includes a pipe part, and the pipe part and the protrusion part are disposed to be apart by 180° in a circumferential direction about the first axis.

In the valve device, a configuration as follows may be adopted: the housing cover includes a fully opened stopper part limiting a movement of the valve part in the state in which the valve part is fully opened.

In the valve device, a configuration as follows may be adopted: a housing body and a housing cover, and a solenoid applying a driving force in a direction of closing the valve part are provided, the cantilevered valve body includes the valve part formed by a magnetic material and the support part formed by a spring material.

In the valve device, a configuration as follows may be adopted: the solenoid is embedded in the cylindrical part of the housing body.

In the valve device, a configuration as follows may be adopted: the solenoid includes: an inner yoke, having a tubular part defining the upstream side passage, the opening part, and a valve seat surface on which the valve part is seated, and forming a magnetic path; an outer yoke, linked with the inner yoke and forming a magnetic path; and a coil for excitation.

In the valve device, a configuration as follows may be adopted: the housing body includes a connector part protruding in a radial direction from the cylindrical part and surrounding a terminal connected with the coil, and the connector part is disposed at a position deviated from the pipe part and the protrusion part in a circumferential direction about the first axis.

In the valve device, a configuration as follows may be adopted: the housing body includes an installation part protruding in the radial direction from the cylindrical part to be installed to an applicable target, and the installation part is disposed at a position deviated from the pipe part, the protrusion part, and the connector part in the circumferential direction about the first axis.

According to the valve device forming the above configuration, the fluid is guided to smoothly flow around the cantilevered valve body, and the pressure loss of the fluid can be reduced.

In the following, the embodiments of the invention will be described with reference to the accompanying drawings.

A valve device according to the invention is, for example, applicable for adjusting the flow of cooling water as a fluid in a cooling water circulation system of a vehicle.

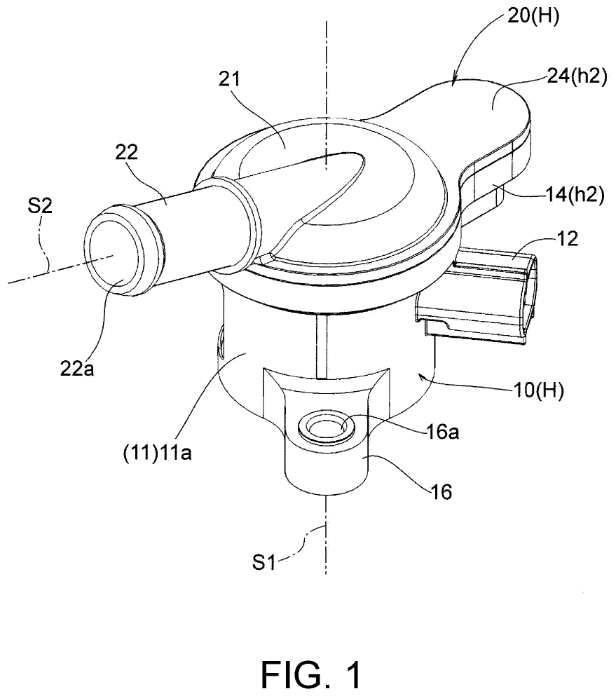

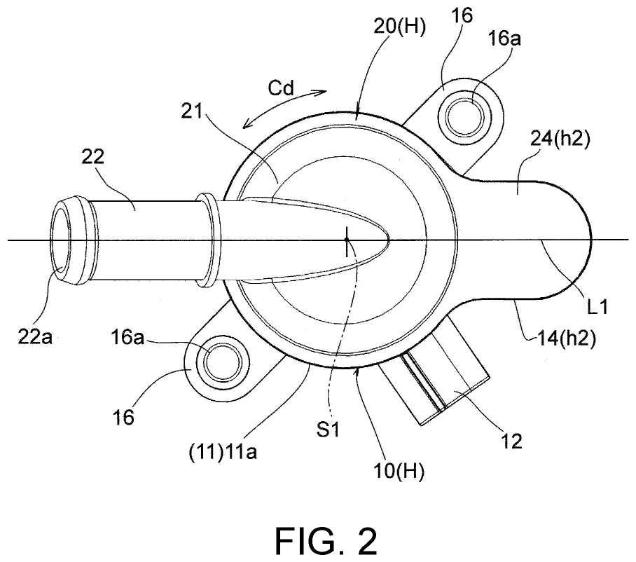

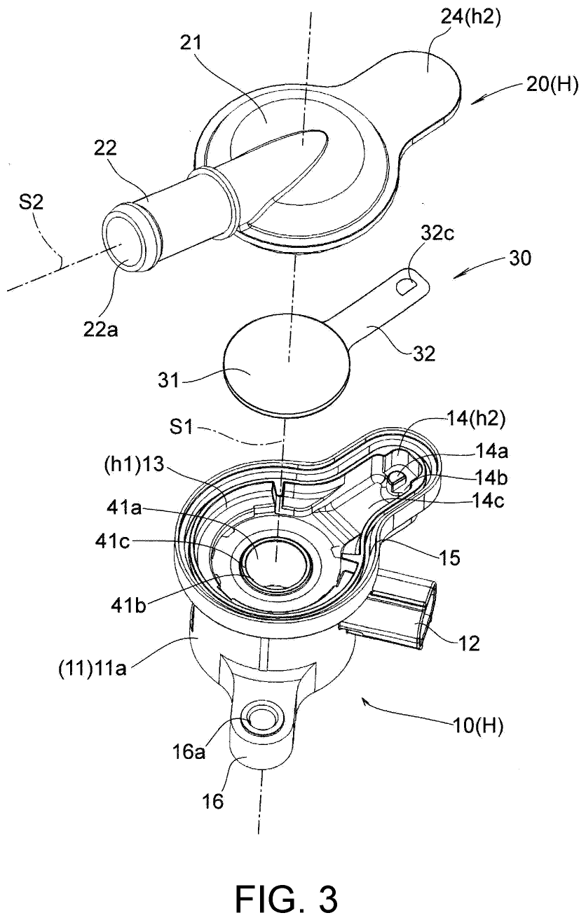

As shown in FIGS. 1 to 8, a valve device according to an embodiment includes a housing body and a housing cover 20 as a housing H, a cantilevered valve body 30, and a solenoid A embedded in the housing body 10.

The solenoid A includes an inner yoke 40, an outer yoke 50, and a coil module 60. The coil module 60 includes a bobbin 61, a coil 62 for excitation, and two terminals 63.

The housing body 10 is formed by a resin material, etc., and includes a cylindrical part 11, a connector part 12, a valve accommodation chamber 13, a protrusion accommodation part 14, a bonding part 15, two installation parts 16, and a bonding part 17 bonded to an applicable target.

The cylindrical part 11 has a cylindrical outer peripheral surface 11a with a first axis S1 as the center, and the solenoid A is embedded on the inner side of the cylindrical part 11.

The connector part 12 is electrically connected with an external connector, and is formed to protrude from the cylindrical part 11 in the radial direction and surround the terminal 63 connected with the coil 62.

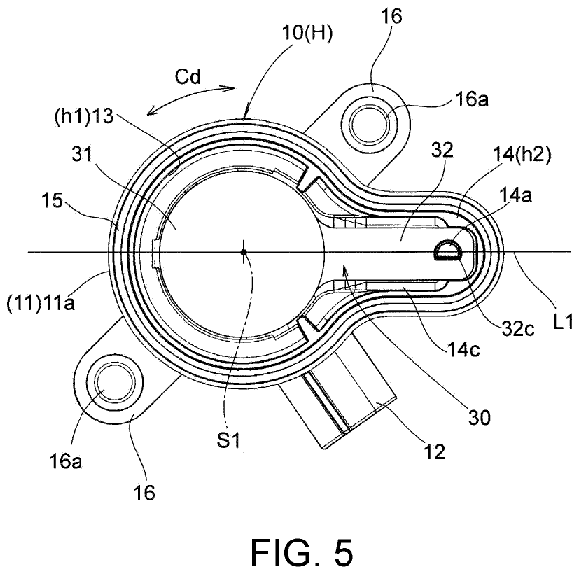

In addition, as shown in FIG. 5, in a circumferential direction Cd about the first axis S1, the connector part 12 is disposed at a position deviated from a line L1 passing through the center of the protrusion accommodation part 14 and orthogonal to the first axis S1.

The valve accommodation part 13 accommodates the cantilevered valve body 30 so that the valve part 31 is able to perform an opening or closing operation, and defines a passage of the fluid so that the fluid can pass through the periphery of the valve part 31 in the state in which the valve part 31 is opened.

The protrusion accommodation part 14 is continuous with the valve accommodation chamber 13 and serves as a valve accommodation chamber, and is a half that partially defines a protrusion part h2 accommodating the fixed side of the cantilevered valve body 30. That is, the protrusion accommodation part 14 is formed to protrude, with the line L1 as the center, from the cylindrical part 11 in the radial direction, so as to accommodate a support part 32 of the cantilevered valve body 30 and fix an end.

In addition, the protrusion accommodation part 14, on the inner side thereof, includes a fitting protrusion 14a fit with an engagement hole 32c of the support part 32, a receiving surface 14b receiving an end of the support part 32 (the periphery part of the engagement hole 32c), and a concave part 14c forming a space separating the wall surface from the support part 32.

The fitting protrusion 14a is positioned to limit the movement of the cantilevered valve body 30 within a plane perpendicular to the first axis S1.

The receiving surface 14b is formed to be inclined downward toward the inner side, so that the support part 32 is elastically deformed in advance to follow the receiving surface 14b, thereby bringing the valve part 31 of the cantilevered valve body 30 into close contact with a valve seat surface 41c.

The concave part 14c is formed so that a foreign matter, etc., included in the fluid is not caught between the support part 32 and the bottom wall surface of the protrusion accommodation part 14.

The bonding part 15 is formed to define the outer profile of the valve accommodation part 13 and the protrusion accommodation part 14, and is bonded by being welded with a bonding part 25 of the housing cover 20.

The two installation parts 16 are formed to protrude from the cylindrical part 11 in the radial direction, fastens the valve device to an applicable target by using a bolt or a screw, etc., and includes a circular hole 16a through which the bolt or the screw passes.

In addition, in the circumferential direction Cd about the first axis S1, the two installation parts 16, as shown in FIG. 5, are disposed at positions deviated from the protrusion accommodation part 14 and the connector part 12 defining a half of the protrusion part h2.

The bonding part 17 is formed to be bonded to the bonding surface of the applicable target, and includes an annular groove 17a for fitting with a seal member, etc.

The housing cover 20 is formed by a resin material, etc., and includes a dome-like cover part 21, a pipe part 22, a valve accommodation chamber 23, a protrusion cover part 24, a bonding part 25, and three fully opened stopper parts 26.

The dome-like cover part 21 is formed to cover the upper part (valve accommodation chamber 13) of the cylindrical part 11 of the housing body 10.

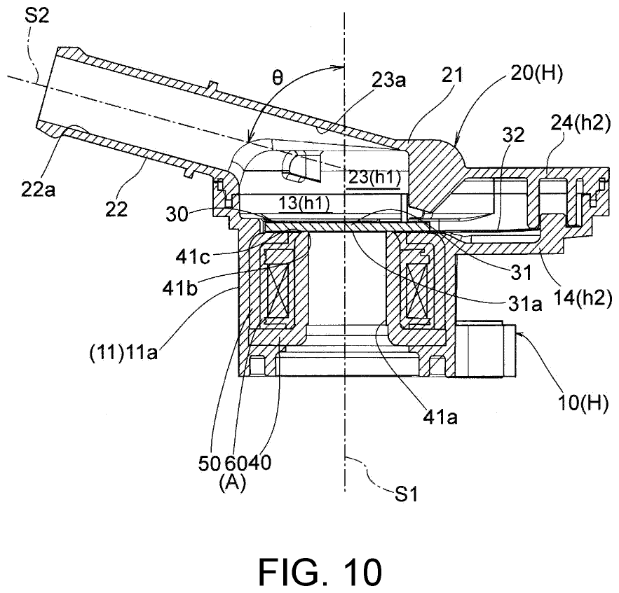

The pipe part 22 is a region with which a fluid lead-out pipe of the applicable target is connected and, as shown in FIG. 10, expands with the second axis S2 as the center, the second axis S2 being inclined to form an angle θ with respect to the first axis S1, and defines the downstream side passage 22a of a circular cross-section with the second axis S2 as the center.

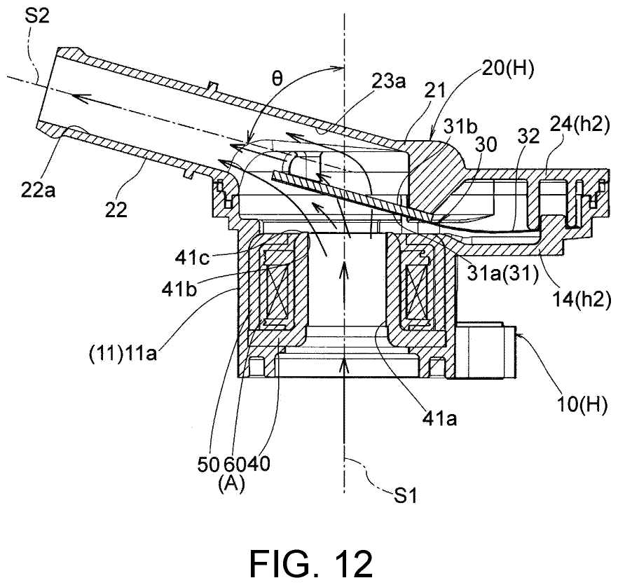

As shown in FIG. 12, in the state in which the valve part 31 of the cantilevered valve part 30 is separated from the valve seat surface 41c to be fully opened, the downstream side passage 22a is formed to expand in a direction along a plane (front surface 31a, back surface 31b) of the valve part 31.

The valve accommodation chamber 23 accommodates the cantilevered valve body 30 so that the valve part 31 is able to perform an opening or closing operation, and, in the state in which the valve part 31 is opened, defines a guide wall 23a guiding the fluid flowing into the side of the back surface 31b of the valve part 31 to the downstream side passage 22a.

As shown in FIG. 12, in the state in which the valve part 31 is fully opened, the guide wall 23a is formed to expand in the direction along the plane (back surface 31b) of the valve part 31. Accordingly, the fluid flowing into the side of the back surface 31b of the valve part 31 is smoothly guided to the downstream side passage 22a along the guide wall 23a.

The protrusion cover part 24 is a half that partially defines the protrusion part h2 accommodating the fixed side of the cantilevered valve body 30. That is, the protrusion cover part 24 is formed to protrude, with the line L1 as the center, in the radial direction to cover the protrusion accommodation part 14 of the housing body 10 accommodating the support part 32 of the cantilevered valve body 30.

In addition, the protrusion cover part 24, on the inner side thereof, includes a fitting hole 24a fit with the fitting protrusion 14a and a pressing part 24b pressing the end of the support part 32 (the periphery part of the engagement hole 32c) against the receiving surface 14b.

The bonding part 25 is formed to define the outer profile of the valve accommodation part 23 and the protrusion cover part 24, and is bonded by being welded with the bonding part 15 of the housing body 10.

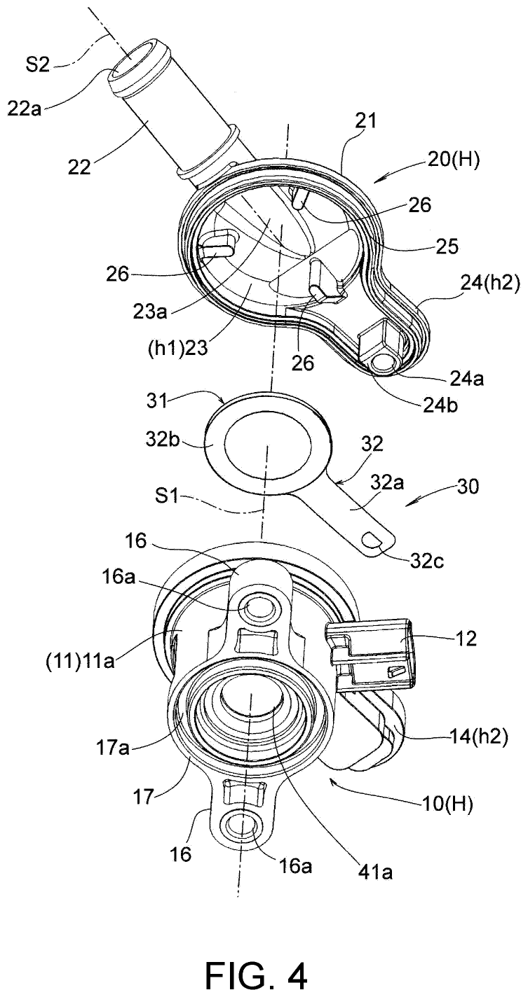

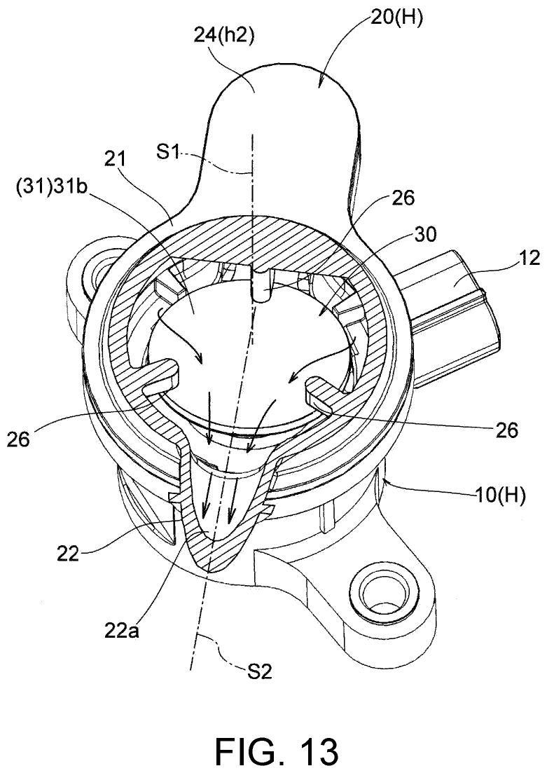

As shown in FIGS. 4 and 13, the three fully opened stopper parts 26 are formed at substantially equal intervals in the circumferential direction about the first axis S1 and, in a region deviated from the downstream side passage 22a, protrude from the inner wall surface of the dome-like cover part 21 toward the inner side.

In addition, the three fully opened stopper parts 26 abut against the back surface 31b of the valve part 31 to limit the movement of the valve part 31 in the state in which the valve part 31 of the cantilevered valve body 30 is fully opened.

In this way, by discretely disposing the three fully opened stopper parts 26 about the first axis S1, through cooperating with the guide wall 23a, the fluid flowing into the side of the back surface 31b of the valve part 31 can be smoothly guided toward the downstream side passage 22a.

In the housing H formed by the housing body 10 and the housing cover 20, a valve accommodation chamber h1 accommodating the cantilevered valve body 30 is formed by using the valve accommodation chamber 13 and the protrusion accommodation part 14 of the housing body 10 and the valve accommodation chamber 23 of the housing cover 20. In addition, by using the protrusion accommodation part 14 of the housing body 10 and the protrusion cover part 24 of the housing cover 20, a protrusion part h2 accommodating the fixed side of the cantilevered valve body 30 is formed.

Here, since the housing H is formed by the housing body 10 and the housing cover 20, in the case of intending to change the orientation of the pipe part 22 defining the downstream side passage 22a within a predetermined range, it is possible to deal with the change by changing only the housing cover 20.

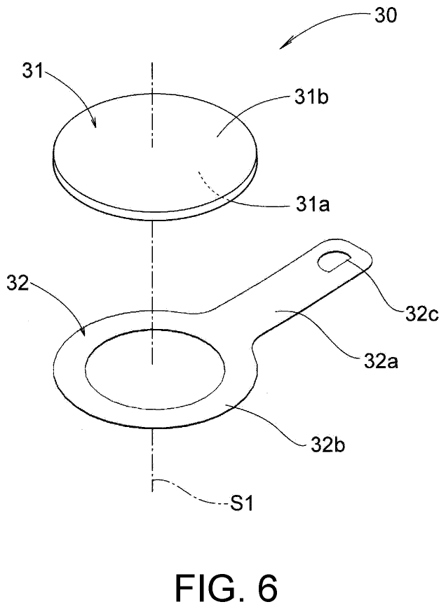

As shown in FIG. 6, the cantilevered valve body 30 includes the valve part 31 and the support part 32.

The valve part 31 is formed in a disc shape by using a magnetic material, such as an iron material, and includes the front surface 31a facing an opening part 41b of the upstream side passage 41a and the back surface 31b opposite to the front surface 31a.

The support part 32 is formed by a material such as a spring steel sheet, and includes an elastically deformable arm part 32a forming an elongated plate shape, a ring-shaped part 32b continuous with the arm part 32a and bonded to the valve part 31 through laser welding, and the engagement hole 32c with which the fitting protrusion 14a is engaged at an end of the arm part 32a.

That is, the cantilevered valve part 30 has the elastically deformable support part 32 and the valve part 31 having a plate shape (disc shape) opening or closing the opening part 41b and located on the free end side of the support part 32.

In addition, in the support part 32, the region (arm part 32a) extending from the valve part 31 is formed in an elongated plate shape.

The cantilevered valve part 30 forming the above configuration, in the protrusion accommodation part 14 of the housing 10, is assembled in a state in which the fitting protrusion 14a is fit with the engagement hole 32c, and the housing cover 20 is bonded to the housing body 10, so that the fitting protrusion 14a is fit with the fitting hole 24a provided at the protrusion cover part 24 of the housing cover 20 while the pressing part 24b presses the periphery part of the engagement hole 32c against the receiving surface 14b, thereby elastically deforming the arm part 32a in advance and being biased to bring the valve part 31 into close contact toward the valve seat surface 41c.

In addition, the cantilevered valve body 30 is opened by the pressure of the fluid flowing from the upstream side passage 41a, and is closed by overcoming the pressure of the fluid by using the driving force (attraction force) of the solenoid A.

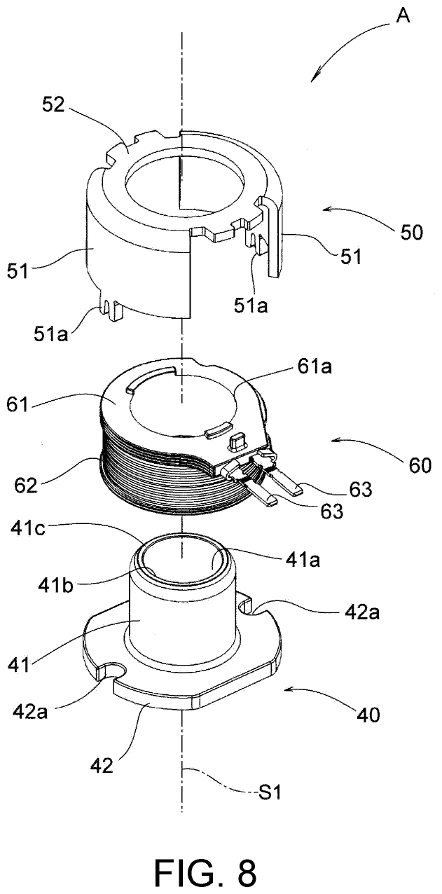

The solenoid A applies a driving force in the direction of closing the valve part 31 of the cantilevered valve body 30, and, as shown in FIG. 8, includes the inner yoke 40 forming a magnetic path, the outer yoke 50 forming a magnetic path, and the coil module 60.

The inner yoke 40 is formed by machining or casting using soft iron, etc., and includes a tubular part 41 and a flange part 42.

The tubular part 41 is formed in a cylindrical shape with the first axis S1 as the center, and defines, on the inner side thereof, the upstream side passage 41a forming a circular cross-section and expanding on the first axis S1, the opening part 41b having a circular shape and located at the downstream end of the upstream side passage 41a, and the valve seat surface 41c that is ring-shaped and formed on the periphery of the opening part 41b.

The flange part 42 is formed in an annular shape extending in a direction perpendicular to the first axis S1 at the upstream end of the upstream side passage 41a, and includes two notch parts 42a in an outer edge region.

The outer yoke 50 is formed by machining or casting using soft iron, and includes two arced wall parts 51 with the first axis S1 as the center and a ring-shaped part 52 facing the flange part 42 in the direction of the first axis S1.

The arced wall part 51 includes an engagement claw 51a at an end in the direction of the first axis S1.

The coil module 60 includes the bobbin 61 defining a through hole 61a and formed by a resin material, the coil 62 for excitation wound on the bobbin 61, and two terminals 63 partially embedded in the bobbin 61 and respectively connected to two ends of the coil 62.

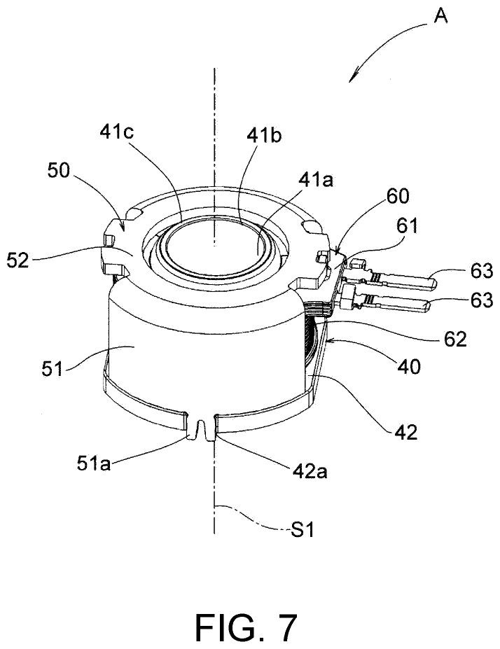

In addition, the tubular part 41 of the inner yoke 50 is fit with the through hole 61a of the coil module 60, the outer yoke 50 is assembled to sandwich the coil module 60, the engagement claw 51a is engaged to the notch part 42a, and the tubular part 41 is fit with the ring-shaped part 52. Accordingly, as shown in FIG. 7, the solenoid A is formed.

In addition, the solenoid A is embedded in the inner region of the cylindrical part 11 when the housing body 10 is molded by using a resin material.

Then, the operation in the case where the valve device according to an embodiment is applied to a cooling water circulation system of a vehicle, for example, is described.

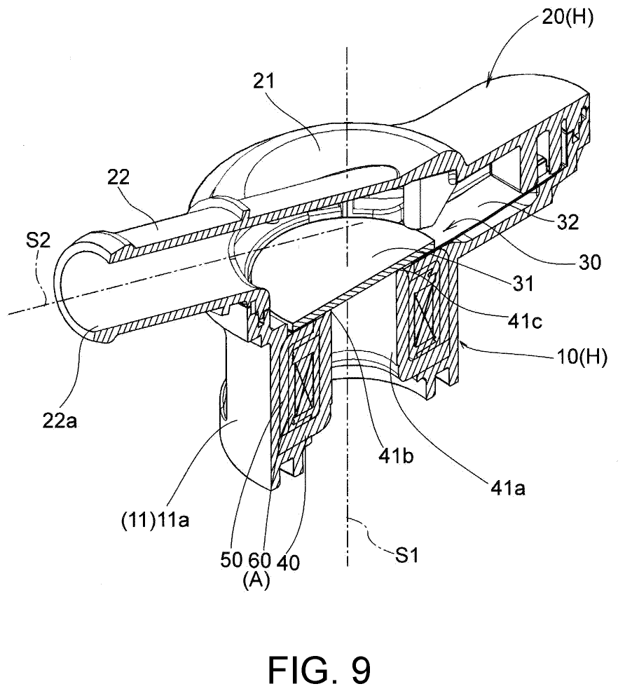

Firstly, when the coil 62 is not conducted with power and the pressure of the fluid is at a predetermined level or lower, as shown in FIGS. 9 and 10, the cantilevered valve body 30 is positioned in a valve-closed state in which the valve part 31 is seated at the valve seat surface 41c to block the opening part 41b.

Then, when the pressure of the fluid increases to exceed the predetermined level, with the fluid flowing in from the upstream side passage 41a, the support part 32 is elastically deformed and the valve part 31 is pushed open toward the downstream side.

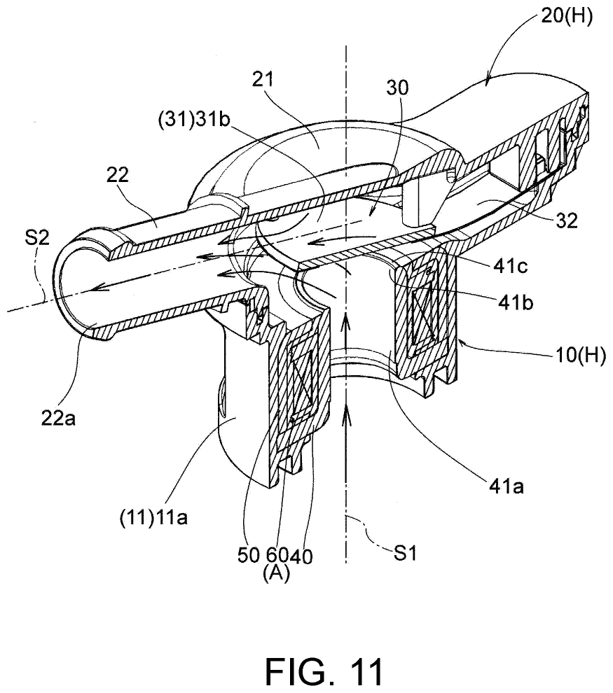

In addition, when the back surface 31b of the valve part 31 is abuts against the fully opened stopper parts 26 to be positioned at the fully opened position, as shown in FIGS. 11 and 12, in the state in which the valve part 31 is fully opened, the direction in which the plane (front surface 31a, back surface 31b) of the valve part 31 extends conforms to the direction in which the downstream side passage 22a expands. That is, the downstream passage 22a expands in the direction along the plane (front surface 31a, back surface 31b) of the valve part 31.

In such state, the fluid flowing in from the upstream side passage 41a is guided to the downstream side passage 22a along the front surface 31a of the valve part 31. In addition, the fluid flowing in from the upstream side passage 41a enters the side of the back surface 31b of the valve part 31 and flows along the back surface 31b, and is guided by the guide wall 23a to be guided to the downstream side passage 22a.

In addition, as shown in FIG. 13, the two fully opened stopper parts 26 formed near the downstream side passage 22a is formed in a region deviated from the downstream side passage 22a. Therefore, in the fully opened state, the fluid entering the side of the back surface 31b of the valve part 31 is guided along the back surface 31b and flows to the downstream side passage 22a without being interfered by the two fully opened stopper parts 26.

Meanwhile, in the state in which the fluid is not guided from the upstream side, when the coil 62 is conducted with power, due to the electromagnetic force (attraction force) generated by the solenoid A, the valve part 31 is drawn toward the side of the inner yoke 40 and, as shown in FIGS. 9 and 10, the valve part 31 is seated at the valve seat surface 41c and in the valve-closed state to block the opening part 41b. In the valve-closed state, it is set that, even if the pressure of the fluid on the upstream side increases to the predetermined level (maximum pressure in the system), the valve-closed state is maintained.

In addition, when the fluid is required to flow toward the downstream side, the power to the coil 62 is cut off, and, due to the pressure of the fluid, the valve part 31 is separated from the valve seat surface 41c and becomes the valve-opened state in which the opening part 41b is opened, as shown in FIGS. 11 and 12.

In the valve-opened state, as described above, the fluid flowing in from the upstream side passage 41a is guided to flow to the downstream side passage 22a along the front surface 31a of the valve part 31, and enters the side of the back surface 31b of the valve part 31 and flows along the back surface 31b and is guided by the guide wall 23a to be guided to the downstream side passage 22a.

In addition, after the valve is opened, even if the coil 62 is conducted with power, the valve part 31 maintains the valve-opened state by using the pressure of the fluid, and when the flow of the fluid from the upstream side stops, the valve part 31 is seated to the valve seat surface 41c to be closed.

The valve device according to the configuration includes: the housing H defining the upstream side passage 41a and the downstream side passage 22a through which the fluid passes, the valve accommodation chamber h1 (13, 23) interposed between the upstream side passage 41a and the downstream side passage 22a, and the opening part 41b located at the downstream end of the upstream side passage 41a; and the cantilevered valve body 30 disposed in the valve accommodation chamber h1 and having the support part 32 elastically deformable and cantilevered and, on the free end side of the support part 32, the valve part 31 being plate-shaped and opening and closing the opening part 41b. The downstream side passage 22a is formed to expand in the direction along the plane (front surface 31a and back surface 31b) of the valve part 31 in the state in which the valve part 31 is fully opened.

Accordingly, in the state in which the cantilevered valve body 30 is fully opened, after passing through the opening part 41b, the fluid flowing in from the upstream side passage 41 flows along the plane (front surface 31a, back surface 31b) of the inclined valve part 31 and smoothly flows to the downstream side passage 22a in such flow direction. Therefore, the flow on the side of the back surface 31b of the valve part 31 is not separated or stagnated, and the pressure loss of the fluid can be decreased.

In addition, the opening part 41b at the downstream end of the upstream side passage 41 is formed to be circular, the valve part 31 is formed in a disc shape, and, in the support part 32, the region extending from the valve part 31 is formed in an elongated plate shape.

Therefore, compared with the case where, for example, the entire cantilevered valve body is in a rectangular shape, the fluid can flow along the back surface 31b while smoothly entering the side of the back surface 31b from the outer peripheral edge of the valve body 31, and flow to the downstream side passage 22a along the back surface 31b, and the pressure loss can be reduced.

In addition, the housing H includes: the cylindrical part 11 defining the upstream side passage 41a to expand on the first axis S1; the pipe part 22 defining the downstream side passage 22a so as to set the second axis S2 as the center and expand on the second axis S2, the second axis S2 being inclined with respect to the first axis S1; and the protrusion part h2 protruding in the radial direction from the cylindrical part 11 to define a portion of the valve accommodation chamber, so as to accommodate the fixed side of the cantilevered valve body 30.

Accordingly, the downstream side passage 22a is defined by the pipe part 22, and the fixed side of the cantilevered valve body 30 is disposed inside the protrusion part h2. Therefore, compared with the case of being formed in a housing with a large outer diameter, the area of the upstream side passage 41a can be ensured, the outer diameter dimension of the cylindrical part 11 can be reduced, and the size of the housing H can be reduced.

In addition, it is configured that the valve part 31 includes the front surface 31a facing the opening part 41b located at the downstream end of the upstream side passage 41a and the back surface 31b on the side opposite to the front surface 31a, and the housing H includes the guide wall 23a that guides the fluid flowing into the side of the back surface 31b to the downstream side passage 22a in the state in which the valve part 31 is fully opened.

Accordingly, the fluid flowing to the side of the back surface 31b of the valve part 31 is guided to the downstream side passage 22a along the guide wall 23a. Therefore, the pressure loss of the fluid can be reduced.

In particular, the guide wall 23a is formed to expand in the direction along the plane (back surface 31b) of the valve part 31 in the state in which the valve part 31 is fully opened. Therefore, the guide wall 23a can smoothly guide the fluid flowing into the side of the back surface 31b toward the downstream side passage 22a.

In addition, it is configured that the pipe part 22 defining the downstream side passage 22a and the protrusion part h2 (protrusion accommodation part 14 and protrusion cover part 24) accommodating the fixed side of the cantilevered valve body 30 are disposed to be apart by 180° in the circumferential direction Cd about the first axis S1.

Accordingly, the downstream side passage 22a is disposed to face a region in which the opening amount (lift amount) is the maximum when the valve part 31 is inclined and fully opened, and the fluid can be more smoothly guided to the downstream side passage 22a.

In addition, it is configured that the housing H includes the fully opened stopper parts 26 limiting the movement of the valve part 31 in the state in which the valve part 31 is fully opened.

Accordingly, by pressing the back surface 31b by using the fully opened stopper parts 26 and acting the fluid pressure on the front surface 31a, the valve body 31 can be reliably positioned at the fully opened position. Accordingly, a stable flow of the fluid can be attained.

In addition, it is configured that the solenoid A applying the driving force in the direction of closing the valve part 31 is provided, and the cantilevered valve body 30 includes the valve part 31 formed by a magnetic material and the support part 32 formed by a spring material. Accordingly, in addition to opening or closing the cantilevered valve body 30 by only using the pressure of the fluid, the valve part 31 can be attracted to maintain the valve-closed state by using the electromagnetic force (attraction force) of the solenoid A.

In addition, it is configured that the housing H includes: the housing body 10 defining the upstream side passage 41a; and the housing cover 20 defining the downstream side passage 22a and combined with the housing body 10, the housing body 10 has the cylindrical part 11 and the protrusion accommodation part 14 partially defining the protrusion part h2, and the housing cover 20 has the pipe part 22 and the protrusion cover part 24 partially defining the protrusion part h2 and covering the protrusion accommodation part 14.

Accordingly, in the case of intending to change the orientation of the downstream side passage 22a (orientation of the second axis S2) within a predetermined range, it is possible to deal with the change by changing only the housing cover 20.

In addition, it is configured that the solenoid A is embedded in the cylindrical part 11 of the housing body 10, and includes: the inner yoke 40 having the cylindrical part 41 defining the upstream side passage 41a, the opening part 41b, and the valve seat surface 41c and forming a magnetic path; the outer yoke 50 linked with the inner yoke 40 and forming a magnetic path; and the coil 62 for excitation.

Accordingly, by embedding the solenoid A in the cylindrical part 11 and using the tubular part 41 of the inner yoke 40 as the upstream side passage 41a through which the fluid passes, compared with the case where the upstream side passage is formed separately, the diameter of the cylindrical part 11 can be reduced, and the size of the device can be reduced.

In addition, in the circumferential direction Cd about the first axis S1, the connector part 12 is disposed at a position deviated from the pipe part 22 and the protrusion part h2. Accordingly, the fluid lead-out pipe of the applicable target can be easily connected to the pipe part 22, or the connector part 12 can be easily connected to the external connector for electrical connection.

In addition, the housing body 10 includes the installation parts 16 protruding in the radial direction from the cylindrical part 11 to be installed to the applicable target. The installation parts 16 are disposed, in the circumferential direction Cd about the first axis S1, at positions deviated from the pipe part 22, the protrusion part h2, and the connector part 12.

Accordingly, the connection of the fluid lead-out pipe to the pipe part 22, the connection of the external connector to the connector part 12, and the installation of the installation parts 16 to the applicable target can be easily carried out without interference with each other. That is, an arrangement configuration favorable for fitting can be attained.

In the above embodiment, the housing H formed by the housing body 10 and the housing cover 20 is shown as the housing. However, the invention is not limited thereto. An integral housing may also be adopted.

In the above embodiment, the upstream side passage 41a in which the upstream side passage is defined by the tubular part 41 of the inner yoke 40 forming the solenoid A. However, the invention is not limited thereto. In the case where the housing is formed through resin molding, the upstream side passage may also be defined by a component of the housing.

In the above embodiment, as the cantilevered valve body, the cantilevered valve body integrally formed by welding the disc-shaped valve part 31 including another component and the elongated plate-shaped support part 32 is shown. However, the invention is not limited thereto. An integrally formed cantilevered valve body or a cantilevered valve body forming another configuration and properly fitting the shape of the path or the shape of the valve seat surface may also be adopted.

In the above embodiment, a configuration including the solenoid A applying a driving force in the direction of closing the valve part 31 is shown. However, the invention is not limited thereto. It may also be configured that the solenoid A is omitted, and the valve part of the cantilevered valve body is opened or closed only by the pressure of the fluid.

In the above embodiment, as the solenoid applying a driving force closing the valve part 31, the solenoid A which, when the valve part 31 is temporarily opened and the fluid keeps flowing, does not generate the attraction force that closes the valve part 31 even if the coil 62 is conducted with power. However, the invention is not limited thereto. Depending on the system as applied, a solenoid which generates an electromagnetic force that is able to overcome the pressure of the fluid and mandatorily close the valve part 31 may also be adopted.

According to the above, in the valve device according to the invention, the fluid can be guided to smoothly flow around the cantilevered valve body to reduce the pressure loss of the fluid. Therefore, in addition to being applicable to a cooling water circulation system of a vehicle, etc., the valve device according to the invention is also useful in an apparatus that controls the flow of a fluid in other fields.

What is claimed is:

1. A valve device, comprising:
a housing, defining an upstream side passage and a downstream side passage through which a fluid passes, a valve accommodation chamber interposed between the upstream side passage and the downstream side passage, and an opening part located at a downstream end of the upstream side passage; and
a cantilevered valve body, disposed in the valve accommodation chamber, and having a support part that is elastically deformable and cantilevered and, on a free end side of the support part, a valve part that is plate-shaped and opens and closes the opening part,
wherein the downstream side passage is formed to expand in a direction along a plane of the valve part in a state in which the valve part is fully opened.

2. The valve device as claimed in claim 1, wherein the opening part is formed to be circular,
the valve part is formed to be disc-shaped, and
a region, of the support part, extending from the valve part is formed in an elongated plate shape.

3. The valve device as claimed in claim 2, wherein the housing comprises: a cylindrical part, defining the upstream side passage to expand on a first axis; a pipe part, defining the downstream side passage to expand on a second axis inclined with respect to the first axis, with the second axis being set as a center; and a protrusion part, protruding in a radial direction from the cylindrical part to define a portion of the valve accommodation chamber, so as to accommodate a fixed side of the cantilevered valve body.

4. The valve device as claimed in claim 3, wherein the valve part comprises a front surface facing the opening part and a back surface on a side opposite to the front surface, and
the housing comprises a guide wall guiding the fluid flowing into a side of the back surface to the downstream side passage in the state in which the valve part is fully opened.

5. The valve device as claimed in claim 4, wherein the guide wall is formed to expand in a direction along the plane of the valve part in the state in which the valve part is fully opened.

6. The valve device as claimed in claim 3, wherein the pipe part and the protrusion part are disposed to be apart by 180° in a circumferential direction about the first axis.

7. The valve device as claimed in claim 3, wherein the housing comprises a fully opened stopper part limiting a movement of the valve part in the state in which the valve part is fully opened.

8. The valve device as claimed in claim 1, comprising:
a solenoid applying a driving force in a direction of closing the valve part,
wherein the cantilevered valve body comprises the valve part formed by a magnetic material and the support part formed by a spring material.

9. The valve device as claimed in claim 3, wherein the housing comprises a housing body defining the upstream side passage and a housing cover defining the downstream side passage and combined with the housing body,
the housing body has the cylindrical part and a protrusion accommodation part partially defining the protrusion part, and
the housing cover comprises the pipe part and a protrusion cover part partially defining the protrusion part and covering the protrusion accommodation part.

10. The valve device as claimed in claim 9, wherein the valve part comprises a front surface facing the opening part and a back surface on a side opposite to the front surface, and
the housing cover comprises a guide wall guiding the fluid flowing into a side of the back surface to the downstream side passage in the state in which the valve part is fully opened.

11. The valve device as claimed in claim 10, wherein the guide wall is formed to expand in a direction along the plane of the valve part in the state in which the valve part is fully opened.

12. The valve device as claimed in claim 9, wherein the pipe part and the protrusion part are disposed to be apart by 180° in a circumferential direction about the first axis.

13. The valve device as claimed in claim 9, wherein the housing cover comprises a fully opened stopper part limiting a movement of the valve part in the state in which the valve part is fully opened.

14. The valve device as claimed in claim 9, comprising:
a solenoid applying a driving force in a direction of closing the valve part,
wherein the cantilevered valve body comprises the valve part formed by a magnetic material and the support part formed by a spring material.

15. The valve device as claimed in claim 14, wherein the solenoid is embedded in the cylindrical part.

16. The valve device as claimed in claim 15, wherein the solenoid comprises: an inner yoke, having a tubular part defining the upstream side passage, the opening part, and a valve seat surface on which the valve part is seated, and forming a magnetic path; an outer yoke, linked with the inner yoke and forming a magnetic path; and a coil for excitation.

17. The valve device as claimed in claim 16, wherein the housing body comprises a connector part protruding in a radial direction from the cylindrical part and surrounding a terminal connected with the coil, and
the connector part is disposed at a position deviated from the pipe part and the protrusion part in a circumferential direction about the first axis.

18. The valve device as claimed in claim 17, wherein the housing body comprises an installation part protruding in the radial direction from the cylindrical part to be installed to an applicable target, and
the installation part is disposed at a position deviated from the pipe part, the protrusion part, and the connector part in the circumferential direction about the first axis.
